(19) United States
(12) Patent Application Publication
(10) Pub. No.: US 2007/0274286 A1
(43) Pub. Date: Nov. 29, 2007

(54) Overhead reduction in an ad-hoc wireless network

(76) Inventor: Ranganathan Krishnan, San Diego, CA (US)

Correspondence Address: QUALCOMM INCORPORATED, 5775 MOREHOUSE DR., SAN DIEGO, CA, 92121, US

(21) Appl. No.: 11/440,539

(22) Filed: May 24, 2006

(51) Int. Cl. H04L 12/28

(52) U.S. Cl. 370/351

(57) ABSTRACT

Embodiments describe reducing overhead in a multihop ad-hoc wireless network. According to an embodiment is a method for routing communication in a multihop ad-hoc network. The method can include receiving an incoming label value and communication, accessing a table that includes node routing information, and identifying a destination device for the communication. The incoming label value can be switched with an outgoing label value that includes the identification of the destination device. The outgoing label value can be inserted between a MAC layer and an IP layer.

### BACKGROUND

I. Field

The following description relates generally to wireless networks and more particularly to overhead reduction in a multihop ad-hoc wireless network environment.

II. Background

Wireless communication networks are commonly utilized to communicate information regardless of where a user is located (inside or outside a structure) and whether a user is stationary or moving (e.g., in a vehicle, walking). Generally, wireless communication networks are established through a mobile device communicating with a base station or access point. The access point covers a geographic range or cell and, as the mobile device is operated, it may move in and out of these geographic cells. To achieve uninterrupted communication the mobile device deregisters with the cell it is exiting and registers with the cell it has entered.

In some embodiments, a network can be constructed utilizing solely peer-to-peer communication without utilizing access points. In further embodiments, the network can include both access points (infrastructure mode) and peer-to-peer communication. These types of infrastructure are referred to as ad-hoc networks or independent basic service sets (IBSS). Ad-hoc networks can be self-configuring whereby when a mobile device (or access point) receives communication from another mobile device, the other mobile device is added to the network. As the mobile devices leave the area, they are dynamically removed from the network. Thus, the topography of the network can be constantly changing.

In a multihop topology, a transmission is transferred though a number of hops or segments, rather than directly from a sender to a recipient. A Voice over Internet Protocol (VoIP) connection can be established between adjacent hops with no end-to-end VoIP connection. Each intermediate node maintains a header compression state for incoming and outgoing VoIP connections and perform the translation from the incoming to the outgoing VoIP connection.

In a multihop ad hoc wireless network environment that utilizes VoIP for decompressing and recompressing of the Internet Protocol/User Datagram Protocol/Real Time Transport Protocol (IP/UDP/RTP) header at each hop can be resource intensive for intermediate terminals that handle multiple voice streams. Moreover, this entails IP forwarding at these intermediate terminals adding to latency, which degrades voice communication quality. The general process is at each hop the header is regenerated (e.g., decompressed and recompressed) and routing is performed based on the regeneration of the header. This process involves a large amount of overhead and adds latency into the process because metadata is added simply for a marker.

To overcome the aforementioned as well as other deficiencies, what is needed is a technique to transmit data in a multihop ad-hoc wireless network while maintaining the low overhead on the wireless medium.

### SUMMARY

In one aspect, a method of routing a packet in a wireless network includes creating a label and inserting the label into a header. The header and an associated packet are compressed and sent to at least a first destination device. The label can be placed between a medium access control layer and an Internet protocol layer. According to some embodiments, the method can include identifying a device that no longer communicates in the wireless network and removing an identification of the device from a routing table. The method can also include identifying a new device in the wireless network, creating an incoming label and an outgoing label for the new device, and adding the incoming label and the outgoing label to a routing table.

In another aspect, a method for routing communication in a multihop ad-hoc network includes receiving an incoming label value and communication, accessing a table that includes node routing information, and identifying a destination device for the communication. The incoming label value can be switched with an outgoing label value that includes the identification of the destination device. The outgoing label value can be inserted between a MAC layer and an IP layer.

In still another aspect, a mobile device for communicating information in an ad-hoc network includes a capturer that receives an incoming traffic and header information that includes an incoming label and a switcher that analyzes the header information and ascertains a replacement label for the incoming label and switches the incoming label with the replacement label. Also included in mobile device is a sender that transmits the traffic and header information that includes the replacement label to a next device. According to some embodiments, the mobile device can include a switcher that accesses a table to correlate the incoming label to the replacement label, a compressor component that compresses a packet header, and/or a decompressor component that decompresses a packet header.

It should be noted that the various methods and operations of apparatus/systems may be implemented using a processor and/or computer readable medium. For example, a computer readable medium may have computer-executable instructions for performing various methods or operation. Similarly, a processor or processors may be configured to perform various methods or operation.

### BRIEF DESCRIPTION OF THE DRAWINGS

FIG. 1 illustrates an example block diagram of a multihop ad-hoc wireless communication system.

FIG. 2 illustrates an example block diagram of another multihop ad-hoc wireless communication system.

FIG. 3 illustrates an example routing communication in a multihop ad-hoc wireless network.

FIG. 4 illustrates an example system that employs machine learning in accordance with the various embodiments presented herein.

FIG. 5 illustrates another example system for communication routing in a wireless ad-hoc network.

FIG. 6 illustrates an example system for transmitting communication packets in a wireless network.

FIG. 7 illustrates an example method for routing communication in a multihop ad-hoc wireless communication network.

FIG. 8 illustrates an example method for automatically renegotiating a communication route in a wireless communication network.

FIG. 9 illustrates an example block diagram of a terminal.

FIG. 10 illustrates an example system for reducing overhead in a multihop ad-hoc wireless network.

FIG. 11 illustrates an example system for routing a packet in a wireless network.

### DETAILED DESCRIPTION

Generally, various aspects are described in connection with incorporating a label between a Medium Access Control (MAC) layer and an IP layer that identifies the traffic. Incoming and outgoing label values can be negotiated at path setup time at each intermediate node. The intermediate node can map the VoIP payload from an incoming stream to an outgoing stream without a change in content and at substantially the same time perform a label switch. The VoIP payload can be compressed at a sending node and arrive intact at a receiving node. The receiving node can perform the decompression to recover the voice payload. More particularly, a multi-protocol label switching (MPLS) type technique is disclosed. The technique allows end-to-end VoIP compression and fast switching of voice streams at intermediate terminals to reduce processing requirements at intermediate nodes and end-to-end latency.

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a user device. A user device can also be called a system, a subscriber unit, subscriber station, mobile station, mobile device, remote station, access point, base station, remote terminal, access terminal, handset, host, user terminal, terminal, user agent, or user equipment. A user device can be a cellular telephone, a cordless telephone, a Session Initiation Protocol (SIP) phone, a wireless local loop (WLL) station, a PDA, a handheld device having wireless connection capability, or other processing device(s) connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

Artificial intelligence based systems (e.g., explicitly and/or implicitly trained classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

Various embodiments will be presented in terms of systems that may include a number of components, modules, and the like. It is to be understood and appreciated that the various systems may include additional components, modules, etc. and/or may not include all of the components, module etc. discussed in connection with the figures. A combination of these approaches may also be used.

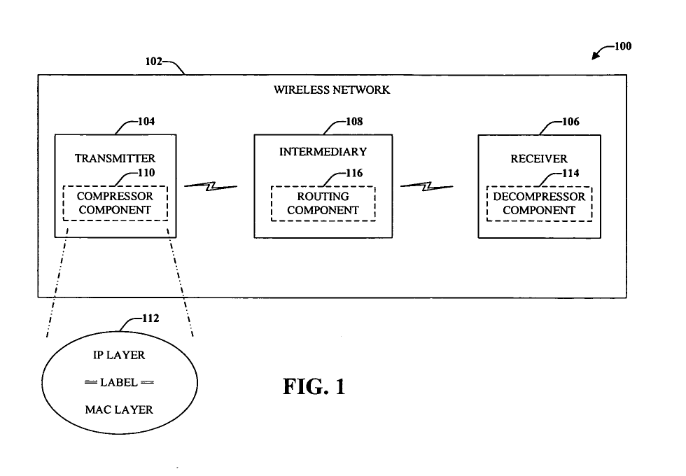

With reference now to the drawings, FIG. 1 is an example block diagram of a multihop ad-hoc wireless communication system 100. System can include a wireless communication network 102. Network 102 can be an ad-hoc wireless communication network, which is a network comprising terminals or stations with no access points. In such a network, devices within the network can function similar to base stations and relay the traffic to other devices, functioning similar to base stations, until the traffic reaches its ultimate destination. In some embodiments, an ad-hoc network can include both terminals and access points.

Wireless network 102 includes a transmitter 104 that can be configured to send a wireless data communication (e.g., voice, sound, text, image, . . . ) to a receiver 106. The wireless communication can be routed through one or more intermediary 108. Although a number of transmitter(s) 104, receiver(s) 106, and/or intermediary 108 can be included in wireless network 102, as will be appreciated, a single transmitter 104 that transmits communication data signals to a single receiver 106 through a single intermediary 108 is illustrated for purposes of simplicity.

Transmitter 104, receiver 106, and/or intermediary 108 can be mobile devices such as, for example, cellular phones, smart phones, laptops, handheld communication devices, handheld computing devices, satellite radios, global positioning systems, PDAs, and/or other suitable devices for communicating over wireless network 102. It should be understood that intermediary 108 can function as a transmitter and/or receiver at substantially the same time as acting as an intermediary. Likewise, transmitter 104 and/or receiver 106 can function as an intermediary at substantially the same time as transmitting and/or receiving a communication or packet.

Transmitter 104 can include a compressor component 110 that can be configured to compress a header 112 of a data communication or data signal (e.g., Voice over Internet Protocol (VoIP)) for transmission to receiver 106. Header 112 can be compressed to a few bytes, for example. Before or at substantially the same time as compression, a label can be added or inserted between an IP layer and a Medium Access Control (MAC) layer, for example. It should be understood that other layers can be included in header 112 and such layers can be in any order and are not limited to the order nor the number of layers shown and described. At substantially the same time as receiving the data communication or data signal, receiver 106, by utilizing a decompressor component 114, can decompress the header 112 of the communication or signal. There is no decompression and/or recompression (e.g., regeneration) of the header occurring at the one or more intermediary 108.

Intermediary 108 can include a routing component 116 that can be configured to ascertain a routing of the data communication between transmitter 104 and receiver 106. Such routing can take into account the label included in the header 112. For example, intermediary 108 can include a routing table or other means for identifying the received label and exchanging the received label with an outgoing label that indicates where the communication is to go next (e.g., another intermediary or receiver). It should be understood that other techniques can be utilized in place of or in conjunction with a routing table. For example, an algorithm or other method for determining an appropriate routing and/or outgoing label (and routing) based on an incoming label can be utilized. An algorithm can generate a number and based on that number, there can be rules that provide as to where to send the data and/or the manner of routing the data.

To ascertain the optimal routing path, routing component 116 can negotiate incoming and outgoing label values, which can be inserted between a MAC layer and an Internet Protocol (IP) layer of the header 112. Intermediary 108 can map the VoIP payload, for example from an incoming stream (e.g., from transmitter 104) to an outgoing stream (e.g., to receiver 106). The mapping can be accomplished without changing the content of the communication. Intermediary 108 can perform a label switch, which includes receiving a label and changing that label based, in part, on the determined routing. The label indicates the intermediaries through which the communication is to go and can indicate the receiver of the information.

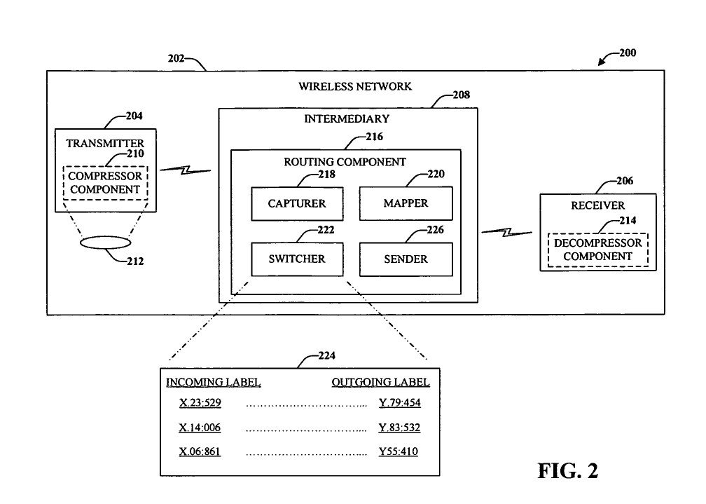

FIG. 2 illustrates an example block diagram of another multihop ad-hoc wireless communication system 200. System 200 includes a wireless network 202 that includes a transmitter 204, a receiver 206 and an intermediary 208 that can communicate wirelessly. It should be understood that network 202 can include more than one transmitter 204, receiver 206, and intermediary 208, however, one of each is illustrated for simplicity purposes. According to some embodiments, intermediary 208 is not utilized to route a communication between transmitter 204 and receiver 206. However, in some embodiments, one or more intermediary 208 is utilized if transmitter 204 and receiver 206 cannot directly communicate.

The communication between transmitter 204 and receiver 206 can be a VoIP communication. VoIP may include the transmission of a voice telephone conversation through the Internet and/or through IP networks. VoIP can be utilized by devices when in the vicinity of a wireless access point (WAP) connected to a broadband network that provides VoIP services. In other situations, transmitter 204 and/or receiver 206 can operate as regular mobile devices while providing communication services.

Intermediary 208 can include a routing component 216 that can be configured to route or direct the communication or traffic in a specific way and can utilize a label switching technique to transmit the traffic in a particular manner. A label can be included in a header 212 that is generated and compressed by transmitter 204. The label can include a value indicating the node or intermediary to which the traffic is directed. Label can be included or inserted between an IP layer and a MAC layer in header 212.

Routing component 216 can include a capturer 218 that can be configured to receive the communication and compressed header 212 from transmitter 204 (or other intermediary). Capturer 218 can be configured to understand or read the label associated with header 214. This understanding and/or reading can be accomplished without the need to regenerate (e.g., compresses and recompress) the header 214 information at intermediary 208. However, the packet can be regenerated in the event that a connection breaks and a communication is reestablished. In such a manner, each intermediary node can recover the communication or packet and send it to the intended recipient.

A mapper 220 can be configured to match the VoIP payload from the incoming stream to an outgoing stream without a change in content. The payload includes information useful to a user and/or entity (e.g., the Internet, another system, a computer, . . . ), such as a message, for example, and can include information relating to a user as well as other information.

At substantially the same time as the mapper is matching or mapping the VoIP payload, a switcher 222 can be configured to exchange, replace, etc. an incoming label with an outgoing label. The label switching is utilized because a label might not have a global meaning, such as an Internet Protocol (IP) address has a unique address, which is specific for that address. The same label can have different meanings at different nodes (e.g., intermediary). Thus, label might have a meaning that is only valid or understood for the next hop (e.g., node, intermediary) where the packet is intended to be transmitted.

Switcher 222 can access a routing table 224 that can include predefined labels that corresponds an incoming label with an outgoing label. The one or more intermediary 208 can be programmed or set up with table 224, which can be unique for each intermediary. A lookup can be performed utilizing table 224 to find an incoming label and its corresponding outgoing label. Thus, if incoming label is X.14:006, that label can be switched with label Y.83:532. The incoming label is removed from the header 212 and replaced with the outgoing label. It should be understood that the incoming labels and the outgoing labels in routing table 224 are not representative of actual labels and are merely for illustration and explanation purposes.

In some embodiments, routing table 224 can take into account various parameters to ascertain the optimal routing or path that the packet traverses, thus labels can be generated for insertion into routing table 224. The parameters can include, for example, the number of intermediaries that is utilized to transmit the communication, the location of the sender, the location of the receiver, the type of communication (e.g., voice, speech, text, image, video, and the like), the size of the communication, and other parameters relating to the communication, sender, receiver, and/or intermediary. According to some embodiments, the optimal routing path includes the fewest intermediaries utilized to transmit the packet. According to other embodiments, the optimal routing path may not be the fewest intermediaries but can be based on other parameters.

Routing component 216 can also include a sender 226 that can be configured to send the communication with the new (outgoing) label to the next intermediary or to the receiver 206. If the packet is sent to another intermediary, that intermediary performs a look up on its routing table and switches the label in a similar manner. A similar process can occur until the packet reaches receiver 206.

Other components can be associated with transmitter 204, receiver 206, and/or intermediary 208. For example, an encode component can be included that can modulate and/or encode signals in accordance with a suitable wireless communication protocol (e.g., Orthogonal Frequency Division Multiplexing (OFDM), Orthogonal Frequency Division Multiplex Access (OFDMA), Code Division Multiple Access (CDMA), Time-Division Multiple Access (TDMA), Global System for Mobile Communications (GSM), High-Speed Downlink Packet Access (HSDPA), . . . ), which signals can then be transmitted to intermediary and/or receiver. Encoder component 208 can be a voice coder (vocoder) that utilizes a speech analyzer to convert analog waveforms into digital signals or another type of encoder. Also included can be a decoder that can decode a received signal and/or data packet therein for processing. Upon successful decode of a data packet, an acknowledgment (ACK) component can generate an acknowledgment that indicates successful decode of the data packet, which can be sent to the packet sender to inform that sender that the data packet was received and decoded, and therefore need not be retransmitted.

It should be understood that transmitter 204, receiver 206, or both, can include routing component and act as an intermediary according to the various disclosed embodiments. For example, in some situations transmitter 204 and/or receiver 206 can be configured to route traffic in wireless network 202 and all such embodiments are intended to fall within the scope of this disclosure.

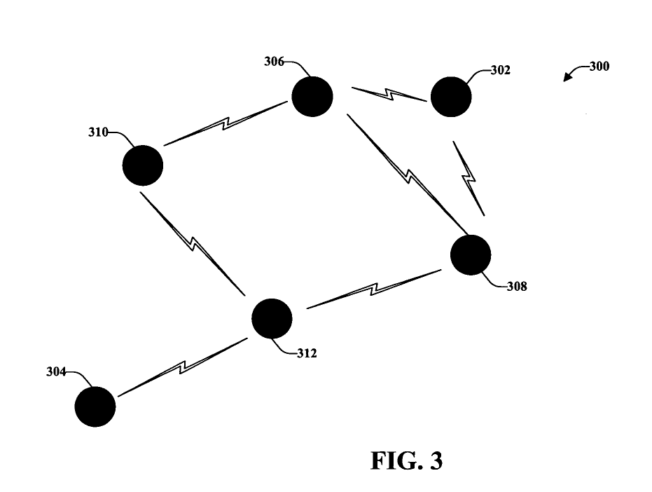

FIG. 3 illustrates example routing communication in a multihop ad-hoc wireless network 300. For example purposes and not limitation, the following will describe a communication routing in a wireless multihop ad-hoc system. System 300 can include any number of mobile devices or nodes, of which six are illustrated, that are in wireless communication. A sender node 302 may wish to communicate with receiver node 304. To enable packet transfer between sender node 302 and receiver node 304, one or more intermediate nodes 306, 308, 310, and/or 312 can be utilized. It should be understood that any node 302-312 can be a sender node, a receiver node and/or an intermediary node.

Sender node 302 can compress a header, associated with the packet. Included in header, between, for example, a MAC layer and an IP layer, is a label that identifies the traffic and receiver node 304 information and/or intermediary node 306-312 information. This label can be inserted by sender node 302 when an initial routing path is established. Intermediate node(s) 306-312 can receive the packet and compressed header and analyze the incoming header without regenerating the header. That is to say, intermediate nodes 306-312 can identify the label, and switch the incoming label with an outgoing label without decompressing and recompressing the header, thus mitigating processing overhead and reducing latency. Each node 302-312 can have stored thereon a listing or table that indicates a label switching or routing pattern. Each label can have a different meaning for each node. In some embodiments, the listing or table can be external to node and maintained in a retrievable manner so that, upon request, node can retrieve the appropriate information. The outgoing label can identify the next node 306-312 to which the packet is being sent, until the packet reaches its destination, which in this example is node 304.

Packet transfer between sender node 302 and receiver node 304 can take various paths. For example, packet can be transferred from sender node 302 to intermediate nodes 308 and 312 and ultimately arrive at its destination, receiver node 304. However, other routes are possible, such as from node 302 to node 306 to node 310 to node 312 and finally to node 304. It should be understood that packet can take a number of different routes or paths to reach its destination and, of course, it is not possible to explain all such routes.

Since nodes 302-312 are mobile devices, they may move in and out of system 300. If a node is moved and can no longer communicate with the other nodes, a different path can be negotiated. A new label scheme can be identified and created eliminating the node, which is no longer included in system. Nodes may also move into to system and a path can be created or negotiated that includes the newly added node(s).

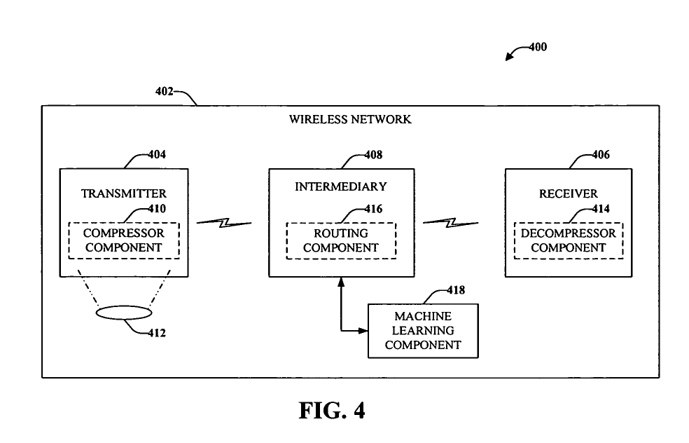

FIG. 4 illustrates an example system 400 that employs machine learning in accordance with the various embodiments presented herein. System 400 includes a wireless network 402, similar to the networks described in conjunction with the preceding figures. Included in wireless network 402 is at least one transmitter 404 that communicates to at least one receiver 406 through at least one intermediary 408. Transmitter 404 includes a compressor component 410 that can be configured to compress a header 412 associated with a data packet. Receiver 406 can include a decompressor component 414 configured to decompress the header 412 and associated packet at substantially the same time as receiving the packet. The intermediary 408 includes a routing component 416 that can be configured to dynamically route the packet based on a layer included in header 412. Machine learning can be effected through machine learning component 418, as illustrated. Machine learning as used herein refers to techniques such as artificial intelligences and/or rules-based logic by which one or more aspect is automated.

The various embodiments (e.g., in connection with routing a data communication in a multihop ad-hoc wireless network 420) can employ various artificial intelligence-based schemes for carrying out various aspects thereof. For example, a process for determining if a particular communication is transmitted to one or more intermediaries can be ascertained through an automatic classifier system and process. Moreover, where multiple communication sources are employed having the same or similar resources, the classifier can be employed to determine which rules and/or polices to employ in a particular situation, communication, transmitter, and/or receiver.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis rules and/or policies) to prognose or infer an action that a user desires to be automatically performed. In the case of multihop industrial networks, for example, rules and/or policies can include routing paths, intermediary locations, and the classes are categories or areas of interest (e.g., transmitter, receiver).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria where to send the packet, when to add or delete a node, etc. The criteria can include, but is not limited to, the type of data or resources to be send, the location of sender, the location of recipient, etc.

In accordance with an alternate aspect that utilizes rules-based logic, an implementation scheme (e.g., rule) can be applied to control and/or regulate a communication path within system 400. It will be appreciated that the rules-based implementation can automatically and/or dynamically regulate routing and appropriate nodes based upon a predefined criterion. In response thereto, the rule-based implementation can send the packet to a particular node by employing a predefined and/or programmed rule(s) based upon any desired criteria (e.g., data type, data size, sender, receiver, intermediary . . . ).

By way of example, a user can establish a rule that can require a trustworthy flag and/or certificate to access a predefined intermediary whereas, other intermediaries within a particular system 400 may not require such security credentials. It is to be appreciated that any preference can be pre-defined or pre-programmed in the form of a rule. It is to be appreciated that other machine learning techniques can be utilized and the subject disclosure is not limited to artificial intelligence and/or rules based logic.

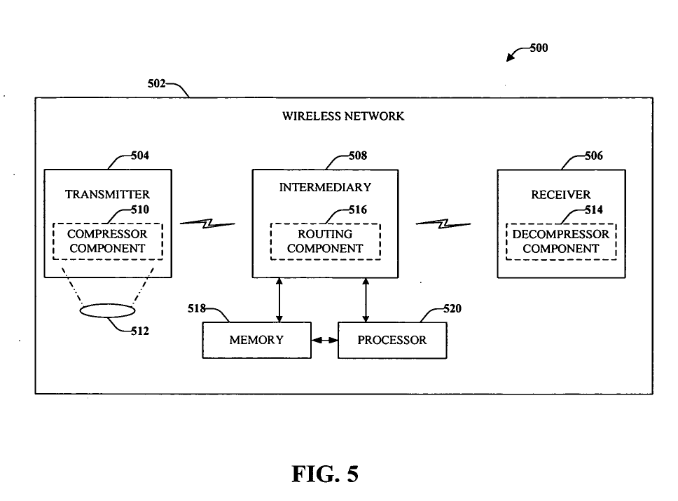

FIG. 5 illustrates another example system 500 for communication routing in a wireless ad-hoc network. System 500 includes a wireless network 502, similar to the networks described in conjunction with the preceding figures. Included in network 502 can be a transmitter 504 that includes a compressor component 510 that can be configured to compress a header 512, a receiver 506 that includes a decompressor component 514 that decompresses a received header and an intermediary 508 that includes a routing component 516. Although a number of transmitter(s) 504, receiver(s) 506, and intermediaries 508 can be included in network 502, a single transmitter 504 that transmits communication data signals or packets to a single receiver 506 through a single intermediary 508 is illustrated for purposes of simplicity.

Network 502 can include a memory 518 operatively coupled to intermediary 508. Memory 518 can store information related to a label for a communication route or path (e.g., routing table, algorithm, . . . ), available intermediary node(s), and/or other parameters associated with transmitting data over a wireless protocol in a multihop ad-hoc network.

A processor 520 can be operatively connected to intermediary 508 (and/or memory 518) to facilitate analysis of information related to ascertaining a particular communication route (e.g., label switching) that is utilized between a transmitter and a receiver. Processor 520 can be a processor dedicated to analyzing and/or generating information communicated to intermediary 508, a processor that controls one or more components of system 500, and/or a processor that both analyzes and generates information received by intermediary 508 and controls one or more components of system 500.

Memory 518 can store protocols associated with data communication rates, operation rates, taking action to control communication between receiver 506 and transmitter 504, etc., such that system 500 can employ stored protocols and/or algorithms to achieve improved communication in a wireless network as described herein. It should be appreciated that the data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (DRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 616 of the disclosed embodiments are intended to comprise, without being limited to, these and other suitable types of memory.

It should be understood that while the above components are discussed with regard to intermediary 508, such components can also be associated with transmitter 504 and/or receiver 506. For various transmission of packets, either transmitter or receiver, or both, can act as an intermediary for other devices that are communicating in network 500.

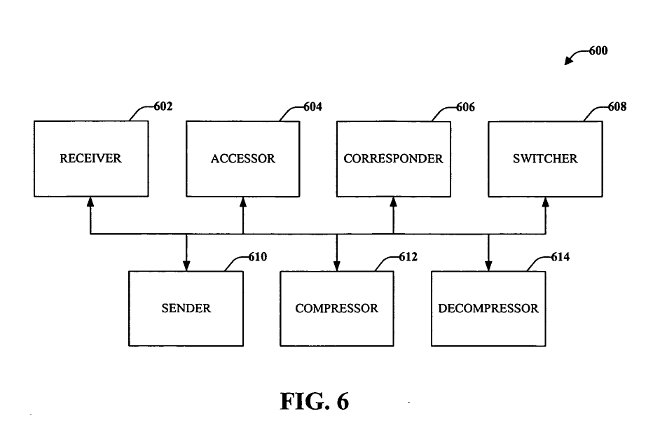

FIG. 6 illustrates an example system for transmitting communication packets in a wireless network. System 600 is represented as functional blocks, which can be functional blocks that represent functions implemented by a processor, software or combination thereof (e.g., firmware). System 600 includes a receiver 602 that can be configured to receive an incoming label value and an associated communication. The label value can indicate a node to which the communication is sent. A accessor 604 can be configured to access a routing table that includes a listing of incoming label values and a corresponding outgoing label value. A corresponder 606 can be configured to correspond the incoming label value with the outgoing label value based on the information contained in the routing table.

System 600 can also include a switcher that can be configured to switch the incoming label with the outgoing label value. It should be understood that the header, in which the label value is included can be compressed prior to being received by receiver 602. The header does not have to be regerenered (e.g., decompressed and recompressed) in order to correspond the incoming label with the outgoing label and/or switching the labels. A sender 608 can be included in system 600 to send the outgoing label value and associated communication to a next node or hop.

According to some embodiments, system 600 can include a compressor 610 that compresses the header that includes the label value. The compressor 610 can compress the header if a communication is to be generated and sent to another device, compressor. System 600 can also include a decompressor 612 that decopresses a received header that includes a label value.

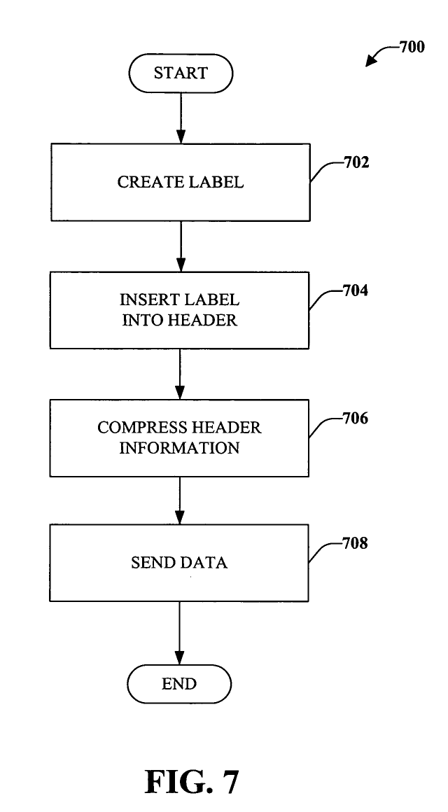

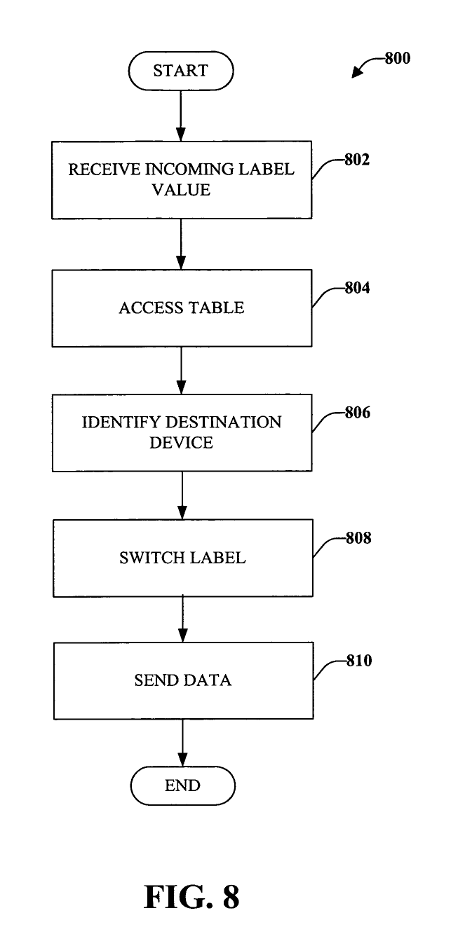

In view of the example systems shown and described above, methodologies, which may be implemented in accordance with one or more aspects of the various embodiments, will be better appreciated with reference to the diagram of FIGS. 7 and 8. While, for purposes of simplicity of explanation, the methodologies are shown and described as a series of acts (or function blocks), it is to be understood and appreciated that the methodologies are not limited by the order of acts, as some acts may, in accordance with these methodologies, occur in different orders and/or concurrently with other acts from that shown and described herein. Moreover, not all illustrated acts may be required to implement a methodology in accordance with one or more aspects of the disclosed embodiments. It is to be appreciated that the various acts may be implemented by software, hardware, a combination thereof or any other suitable means (e.g. device, system, process, component) for carrying out the functionality associated with the acts. It is also to be appreciated that the acts are merely to illustrate certain aspects presented herein in a simplified form and that these aspects may be illustrated by a lesser and/or greater number of acts. Moreover, not all illustrated acts may be required to implement the following methodologies. Those skilled in the art will understand and appreciate that a methodology could alternatively be represented as a series of interrelated states or events, such as in a state diagram.

FIG. 7 is an example method 700 for routing communication in a multihop ad-hoc wireless communication network. When data is to be communicated from one device or node to another device or node, a header is associated with the data. The header can include information that guides the data to its correct destination (e.g., receiver). Typical information included in a header is the sender's address and the receiver's address. A MAC layer and an IP layer can be included in the header. The create the header, an initial packet route can be identified and identification of at least a first destination device (e.g., first hop) can be obtained. The destination device can be an intermediary node and/or a recipient.

The header can also include a label that can be created, at 702. The label can identify the data and an initial route that the data travels to reach its destination. In a multihop ad-hoc network, various intermediary devices or nodes can be utilized to communicate the data from sender to recipient. The label can include identifying information for at least one intermediary device (e.g., the first intermediary to be contacted). The label can be inserted, at 704, in the header between the MAC layer and IP layer.

At 706, the header is compressed and can be compressed as small as a few bytes. In some embodiments, the header can be compressed to a size of one-byte or smaller. The label can be, in some embodiments, around four bits. The data, including the header information, is transmitted, at 708, to receiver and/or intermediary device. In the above methodology 700, a transmitter can create the label, insert the label into a header, compress the header, and send the data.

According to some embodiments, one or more node (e.g., mobile device) can enter and/or leave a communication network. Therefore, method 700 can include identifying a device that no longer communicates in the wireless network and removing an identification of the device from a routing table. Alternatively or in addition, method 700 can include identifying a new device in the wireless network, creating an incoming label and on outgoing label for the new device, and adding the incoming label and the outgoing label to a routing table.

FIG. 8 is an example method 800 for automatically renegotiating a communication route in a wireless communication network. At 802, an incoming label value is received. This label value can be received from a packet sender or an intermediary node and can be included between a MAC layer and an IP layer of a packet header. At substantially the same time as the label value is received, it is interpreted and a routing table is accessed, at 804, to determine where the packet is sent. The routing table can include an incoming label value and a corresponding outgoing label value. Thus, accessing the routing table can identify a next node or destination device (e.g., hop), at 806, since the outgoing label value can indicate the next node to receive the packet (e.g., another intermediary or recipient).

At 808, the incoming label is switched with the outgoing label. The label identification and switching can occur without the header being renegotiated (e.g., decompressed and recompressed). The header, with the outgoing label, and the packet may, as needed, be sent to the next destination device, at 810.

In the above methodology 800, for example, an apparatus (e.g., mobile device) can receive the label, access the table to identify the next device, switch the label, and send the header, with new label, and packet to the next destination device, which can be another intermediary node or the intended recipient.

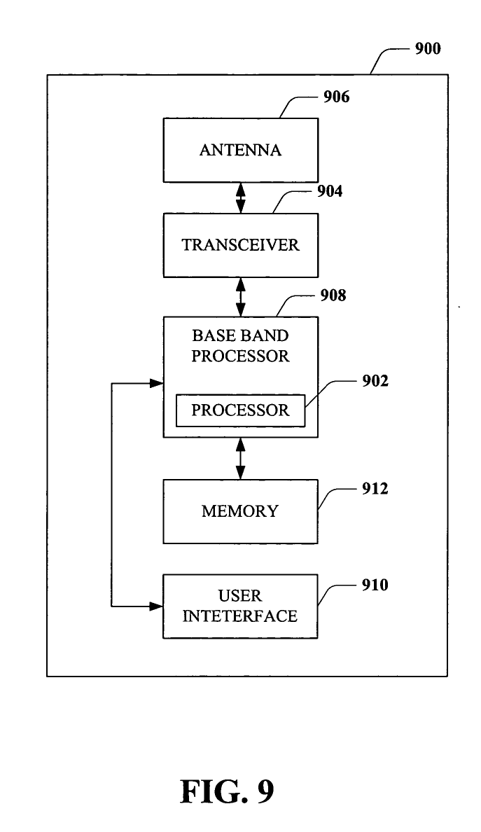

FIG. 9 illustrates an example block diagram of a terminal 900. As those skilled in the art will appreciate, the precise configuration of the terminal 900 may vary depending on the specific application and the overall design constraints. Processor 902 can implement the systems and methods disclosed herein.

Terminal 900 can be implemented with a front-end transceiver 904 coupled to an antenna 906. A base band processor 908 can be coupled to the transceiver 904. The base band processor 908 can be implemented with a software based architecture, or other type of architectures. A microprocessor can be utilized as a platform to run software programs that, among other functions, provide control and overall system management function. A digital signal processor (DSP) can be implemented with an embedded communications software layer, which runs application specific algorithms to reduce the processing demands on the microprocessor. The DSP can be utilized to provide various signal processing functions such as pilot signal acquisition, time synchronization, frequency tracking, spread-spectrum processing, modulation and demodulation functions, and forward error correction.

Terminal 900 can also include various user interfaces 910 coupled to the base band processor 908. User interfaces 910 can include a keypad, mouse, touch screen, display, ringer, vibrator, audio speaker, microphone, camera and/or other input/output devices.

The base band processor 908 comprises a processor 902. In a software-based implementation of the base band processor 908, the processor 902 may be a software program running on a microprocessor. However, as those skilled in the art will readily appreciate, the processor 902 is not limited to this embodiment, and may be implemented by any means known in the art, including any hardware configuration, software configuration, or combination thereof, which is capable of performing the various functions described herein. The processor 902 can be coupled to memory 912 for the storage of data.

It is to be understood that the embodiments described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

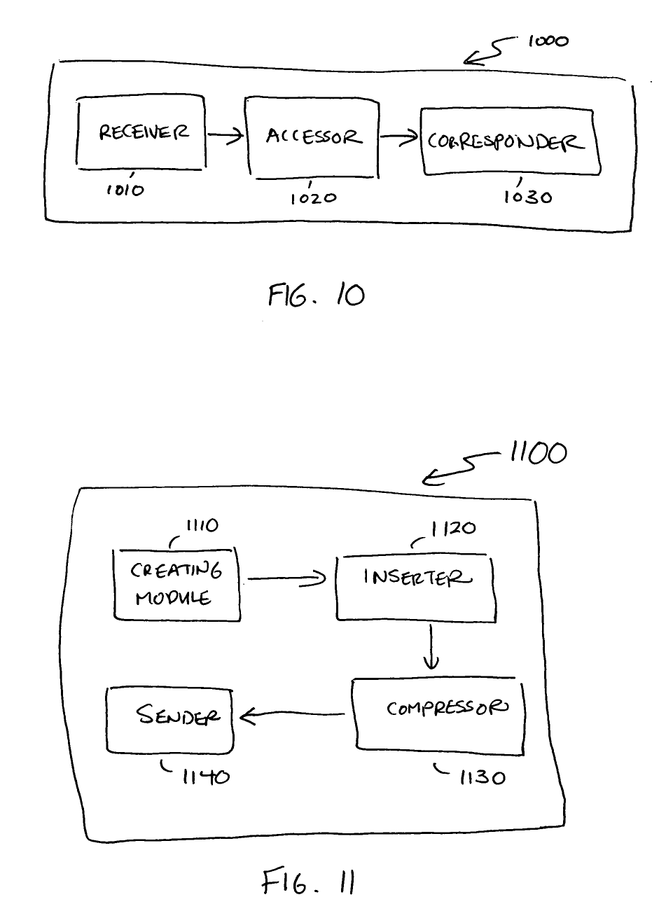

For example, in one aspect, a system for reducing overhead in a multihop ad-hoc wireless network may include means for receiving an incoming label value and associated communication, means for accessing a routing table, and means for corresponding the incoming label value with an outgoing label value. Here, the means for receiving an incoming label value and associated communication may comprise a receiver 1010, the means for accessing may comprise an accessor 1020, and the means for corresponding the incoming label value may comprise a corresponder 1030, as illustrated in system 1000 of FIG. 10.

The system 1000 can also include means for switching the incoming label value with the outgoing label value and means for sending the outgoing label value and associated communication to a next node. The means for switching the incoming label value with the outgoing label value may insert the outgoing label between a medium access control layer and an Internet protocol layer of a header. The system 1000 may further comprise means for compressing a header that includes a label value.

In another example, a system for use in routing a packet in a wireless network may comprise means for creating a label; means for inserting the label into a header; means for compressing the header and an associated packet; and means for sending the compressed header and the associated packet to at least a first destination device. Here, the means for creating a label may comprise creating module 1110 as shown in system 1100 of FIG. 11. The means for inserting may comprise an inserter 1120, the means for compressing may comprise a compressor 1130, and the means for sending may comprise a sender 1140, as shown in system 1100.

The system 1100, before creating a label, may further comprise means for identifying an initial packet route; and means for obtaining identification of the at least a first destination device. The system 1100 may also further comprise means for identifying a device that no longer communicates in the wireless network; and means for removing an identification of the device from a routing table. The system 1100 may further comprise means for identifying a new device in the wireless network; means for creating an incoming label and an outgoing label for the new device; and means for adding the incoming label and the outgoing label to a routing table.

It should be noted that system 1000 and 1100 are examples. Accordingly, one or more elements of system 1000 and/or system 1100 may be combined and/or rearranged without affecting the system. Moreover, additional elements may be added such as a processor and/or memory. Here, it should also be noted that the system 1000 and/or system 1100 may be implemented by a processor or processors configured to carry out one or more functions of system 1000 and/or 1100. Similarly, the system 1000 and/or system 1100 may be implemented by a memory configured to store instructions for performing one or more functions of system 1000 and/or 1100.

Therefore, what has been described above includes examples of one or more embodiments. It is, of course, not possible to describe every conceivable combination of components or methodologies for purposes of describing these embodiments, but one of ordinary skill in the art may recognize that many further combinations and permutations of such embodiments are possible. Accordingly, the embodiments described herein are intended to embrace all such alterations, modifications. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of routing a packet in a wireless network, comprising:
creating a label;
inserting the label into a header;
compressing the header and an associated packet; and
sending the compressed header and the associated packet to at least a first destination device.

2. The method of claim 1, inserting the label into a header comprising placing the label between a medium access control layer and an Internet protocol layer.

3. The method of claim 1, before creating a label further comprising:
identifying an initial packet route; and
obtaining identification of the at least a first destination device.

4. The method of claim 1, the destination device is an intermediary node or an intended recipient.

5. The method of claim 1, further comprising:
identifying a device that no longer communicates in the wireless network; and
removing an identification of the device from a routing table.

6. The method of claim 1, further comprising:
identifying a new device in the wireless network;
creating an incoming label and an outgoing label for the new device; and
adding the incoming label and the outgoing label to a routing table.

7. A method for routing communication in a multihop ad-hoc network, comprising:
receiving an incoming label value and communication;
accessing a table that includes node routing information;
identifying a destination device for the communication; and
switching the incoming label value with an outgoing label value that includes the identification of the destination device.

8. The method of claim 8, further comprising mapping a voice over internet protocol payload to transmit an outgoing stream in substantially a same form as an incoming stream.

9. The method of claim 7, switching the incoming label value with an outgoing label value further comprising placing the outgoing label value between a MAC layer and an IP layer.

10. The method of claim 7, further comprising sending the outgoing label value and communication to a device identified by the outgoing label value.

11. The method of claim 7, the outgoing label value identifies a node to which the outgoing label value and communication is to be sent.

12. A mobile device for communicating information in an ad-hoc network, comprising:
a receiver configured to receive an incoming traffic and header information that includes an incoming label;
a switcher configured to analyzes the header information and ascertains a replacement label for the incoming label and replaces the incoming label with the replacement label; and
a sender configured to transmits the traffic and header information that includes the replacement label to a next device.

13. The mobile device of claim 12, the switcher accesses a table to correlate the incoming label to the replacement label.

14. The mobile device of claim 12, further comprising a compressor component that compresses a packet header.

15. The mobile device of claim 12, further comprising a decompressor component that decompresses a packet header.

16. A system for reducing overhead in a multihop ad-hoc wireless network, comprising:
means for receiving an incoming label value and associated communication;
means for accessing a routing table;
means for corresponding the incoming label value with an outgoing label value;
means for switching the incoming label value with the outgoing label value; and
means for sending the outgoing label value and associated communication to a next node.

17. The system of claim 16, the means for switching the incoming label value with the outgoing label value inserts the outgoing label between a medium access control layer and an Internet protocol layer of a header.

18. The system of claim 16, further comprising means for compressing a header that includes a label value.

19. The system of claim 16, further comprising means for decompressing a header that includes a label value.

20. A computer readable medium having computer-executable instructions for:
creating a label that identifies a communication route;
inserting the label into a header;
compressing the header and an associated packet; and
sending the compressed header and the associated packet to at least a first node in the communication route.

21. The computer readable medium of claim 20, further comprising instructions for:
ascertaining an outgoing label based in part on an incoming label;
removing the incoming label from the header; and
inserting the outgoing label into the header.

22. The computer readable medium of claim 20, further comprising instructions for decompressing a header and an associated packet.

23. A processor that executes instructions for reducing overhead in a communication network, the instructions comprising:
receiving an incoming label value and associated communication;
accessing a routing table;
corresponding the incoming label value with an outgoing label value;
switching the incoming label value with the outgoing label value; and
sending the outgoing label value and associated communication to a next node.

24. Apparatus for use in routing a packet in a wireless network, comprising:
means for creating a label;
means for inserting the label into a header;
means for compressing the header and an associated packet; and
means for sending the compressed header and the associated packet to at least a first destination device.

25. A computer readable medium having computer-executable instructions for:
creating a label;
inserting the label into a header;
compressing the header and an associated packet; and
sending the compressed header and the associated packet to at least a first destination device.

26. A processor that executes instructions for reducing overhead in a communication network, the instructions comprising:
creating a label;
inserting the label into a header;
compressing the header and an associated packet; and
sending the compressed header and the associated packet to at least a first destination device.
